(19) United States
(12) Patent Application Publication
(10) Pub. No.: US 2009/0082116 A1
(43) Pub. Date: Mar. 26, 2009

(54) RETAINER PIN FOR DRIVE SHAFT

(76) Inventors: Bernhard Baechle, Ravensburg (DE); Dietmar Fischer, Kressbronn (DE); Martin Heimerdinger, Meckenbeuren (DE); Klaus Niehaus, Bergisch-Gladbach (DE); Frank Scheider, Tettnang (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/167,313

(22) Filed: Jul. 3, 2008

(30) Foreign Application Priority Data
Jul. 4, 2007 (DE) 102007031186.0-12

(51) Int. Cl. F16C 3/03

(52) U.S. Cl. 464/162

(57) ABSTRACT

The invention relates to a drive shaft (1) comprising partially internested shaft parts (5, 6) which are slidable relative to one another by a predetermined amount in a longitudinal toothing (2), the longitudinal toothing (2) being formed by an inner toothing (4) on the outer, tubular shaft part (6) and by an outer toothing (3) on the inner shaft part (5), the shaft parts (5, 6) being joined together and prevented from being pulled apart axially during installation or transport by use of securing means provided on the outer periphery of the shaft parts. A securing means is provided by a boot (8) which encloses both shaft parts (5, 6) and whose edges (9, 10) cooperate with the shaft parts (5, 6) so as to limit pull-out and form a seal, and at least one edge (10) the boot (8) is axially slidable to a limited extent relative to the shaft part (5) which it encloses. By means of the invention a pull-out protection element may be provided which is easy and economical to manufacture, has a compact design, and performs an additional function.

For the transmission of drive forces in a vehicle, it is known to use drive shafts which permit lateral motions between the drive and output, as well as longitudinal motions. For length compensation, such drive shafts are divided in at least one region of their extension, the parts being internested in longitudinal toothing, and in this manner being joined together so as to be longitudinally displaceable in the axial direction. To compensate for lateral motions the ends of the shaft parts are provided with articulated joints, for example universal joints or rubber joints, which in the installed state are connected to the vehicle. For transport and installation the associated shaft parts must be connected to prevent them from being accidentally pulled out. At the same time, however, this pull-out protection must not interfere with the length compensation during operation.

According to category-defining DE 40 38 882 A1, pull-out protection is provided by locking wires which connect the two shaft parts which are internested in longitudinal toothing. The locking wires prevent the shaft parts from coming apart in the removed state. The displacement paths permitted by the protective element are larger than the maximum extension paths which occur during operation. To prevent lubricant introduced into the longitudinal toothing from escaping to the surroundings and to prevent contaminants from entering, a sliding seal is provided between the outer and inner shaft parts. Installation of the pull-out protection is complicated and therefore costly.

DE 197 09 282 C2 discloses another design of a pull-out protection element for a drive shaft having two universal joints. This pull-out protection is intended not only to prevent two shaft parts which are displaceable inside one another in longitudinal toothing from being pulled apart during installation or transport, but also to prevent the shaft parts from separating if the drive shaft becomes detached from its fastening in the vehicle as the result of a rupture. Therefore, the pull-out protection must be able to absorb correspondingly high forces. The pull-out protection comprises an annular stop which is attached at the end of the inner shaft part by means of a circlip. The outer diameter of the annular stop ring is greater than the inner diameter of the longitudinal toothing of the outer shaft part. When there is excessive pulling, the motion of the shaft parts is locked by the fact that the stop ring strikes against the longitudinal toothing. The seal for the shaft parts with respect to the surroundings is provided once again by a sliding seal. Manufacture of the described pull-out protection element is complicated. Installation, and in particular uninstallation for repairs, is difficult because access to the circlip and the stop ring requires removal of additional parts.

WO 2005/012771 A2 discloses the design of a constant-velocity joint having a boot for the seal. The constant-velocity joint has an inner and an outer connecting piece. The inner connecting piece is connected to a shaft which is able to slide relative to the inner connecting piece. A primary boot is fixedly connected to the outer connecting piece, and together with the shaft forms a sliding seal. Thus, the corresponding edge of the boot is not rigidly coupled to the shaft, but instead allows the shaft to move relative to the boot. To increase the sealing force, the corresponding end of the boot may also be enclosed by a spring clamp. Also provided is a secondary boot which surrounds the primary boot, but which is fixed at both ends in a customary manner known as such, and changes shape when the shaft moves relative to the outer connecting piece.

The object of the present invention stated in Claim 1 is to provide a pull-out protection element which is easy and economical to manufacture, has a compact design, and performs an additional function.

This object is achieved by the features stated in Claim 1. Protection from pull-out is provided by a boot which encloses the two shaft parts, and whose edges cooperate with the shaft parts so as to limit pull-out and form a seal. In order to allow use of a compact boot, but to still permit a sufficient pull-out motion of the two internested shaft parts relative to one another during operation, at least one edge the boot is axially slidable to a limited extent relative to the shaft part which it encloses. It is particularly advantageous that the boot also performs the function of a seal with respect to the surroundings, thus preventing lubricant from escaping from the longitudinal toothing and also preventing contaminants from entering.

Advantageous embodiments are stated in the subclaims.

An annular stop, situated inside the boot, for the edge of the boot which is displaceable relative to the enclosed shaft part is advantageously used as the pull-out limiter which cooperates with the boot.

In one practical design the stop is formed at [sic; by] a clamping ring resting on the shaft part.

The clamping ring is preferably situated on the section of the inner shaft part adjoining the outer toothing of the inner shaft part, the clamping ring being slidable on the inner shaft part in both the pull-out direction by means of entrainment on the edge of the boot, and in the direction opposite the pull-out direction by means of entrainment on the outer shaft part, and the displaceability in the pull-out direction being limited by the outer toothing on the corresponding diameter. This design has the particular advantage that very large displacement paths of the shaft parts relative to one another may be provided by the fact that the clamping ring is freely displaceable between the end of the longitudinal toothing and the axially displaceable edge of the boot.

In another design the stop may be a pull-out-limiting projection that is formed by a difference in diameters.

The stop is preferably formed by the outer toothing of the inner shaft part which projects beyond the adjoining shaft section.

The stop is preferably provided with an inclined ramp.

In one practical design a sealing lip is integrally molded onto the edge of the boot which is displaceable relative to the shaft part.

The sealing lip is preferably oriented on the stop at an angle with respect to the pull-out direction. This is advantageous for installation, since as a result of the boot slipping onto the shaft opposite the pull-out direction the sealing lip folds outward, thereby reducing the force to be applied. The sealing lip is oriented opposite the pull-out direction when it strikes the stop surface, resulting in increased resistance to being pulled out.

However, the sealing edge of the boot may also be provided with two radially oriented sealing lips which delimit a circumferential groove which is open toward the shaft part. A support ring which rests on the outer diameter of the shaft part may be provided in the circumferential groove which is formed by the sealing lips and which is open toward the shaft part. A tensioning element which is pretensioned against the shaft part is advantageously provided on the back side of the contact region.

The support ring may be omitted if sufficient radial rigidity of the edge of the boot is achieved as the result of suitable selection of the boot material, so that, in conjunction with a tension coupling, the required sealing and protection from pull-out are ensured.

The sealing lip is preferably designed in the form of a narrow undulating arc.

The sealing lip may have a collar-shaped design.

To increase the pull-out forces, a tensioning element pretensioned against the shaft part may be provided on the back side of the sealing lip regions. The pretensioning is selected in such a way that a good seal is achieved, while at the same time axial sliding without great resistance is possible.

It is practical to design the tensioning element as a spring washer having a circular or rectangular cross section, as a snap ring, or as a tension coupling.

The pretensioning in each case is selected so that during transport or installation the shaft parts are prevented from accidentally being pulled out, at least under the force of weight.

The extensibility of the boot and the displaceability are adjusted so that for a specified pull-out force the pull-out length of the internested shaft parts is greater, by a specifiable amount, than the maximum pull-out during operation.

One exemplary embodiment of the invention is illustrated in the drawings, and is described in greater detail below. The drawings show the following:

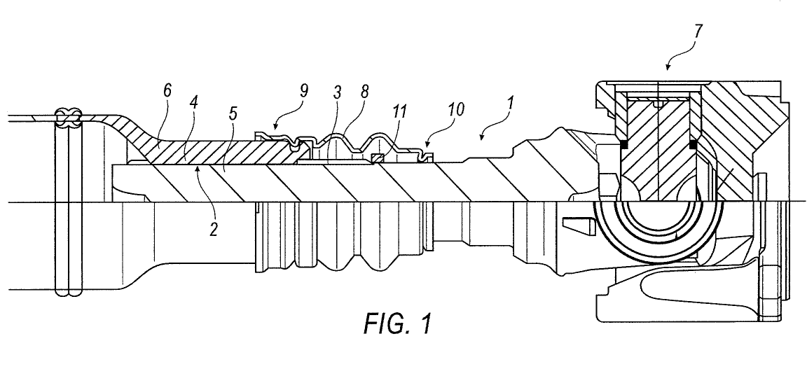

FIG. 1 shows a longitudinal sectional view of a drive shaft composed of two shaft parts which are displaceable relative to one another in longitudinal toothing, and having a boot as a pull-out limiter;

FIG. 2 shows a detailed illustration of the pull-out-limiting parts of the drive shaft illustrated in FIG. 1; and

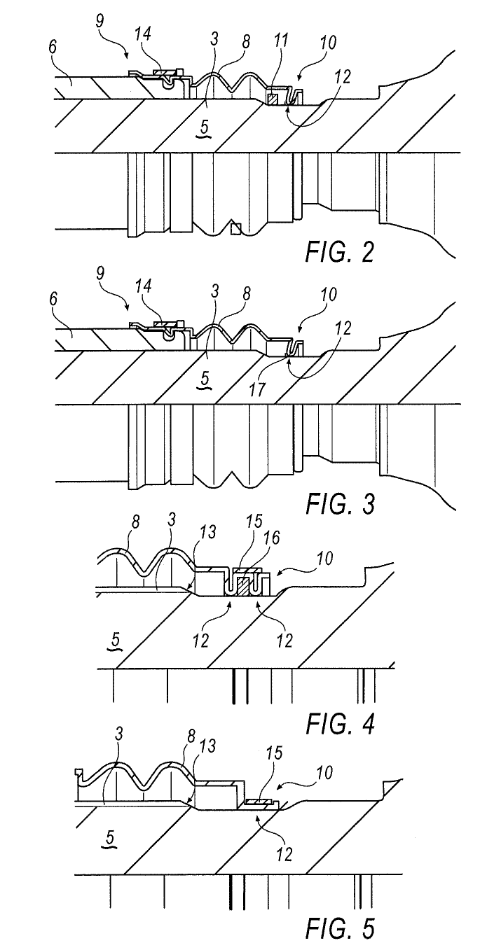

FIGS. 3, 4, and 5 show illustrations, corresponding to FIG. 2, of further design possibilities for pull-out-limiting parts.

FIG. 1 illustrates a drive shaft 1 in a longitudinal sectional view. The drive shaft 1 comprises an inner shaft part 5 which is connected to an articulated joint 7, and an outer shaft part 6 which is connected to an additional articulated joint (not illustrated). The articulated joint 7 is not limited to a universal joint, as illustrated. The shaft parts 5 and 6 are internested in the region of longitudinal toothing 2. For a drive shaft installed in a vehicle, the longitudinal toothing 2 allows displacement of the shaft parts 5, 6 relative to one another. The displacement results from the fact that the vehicle parts connected to the articulated joints undergo motion relative to one another. The longitudinal toothing 2 is formed by an inner toothing 4 on an outer shaft part 6 and by an outer toothing 3 on the inner shaft part 5. A boot 8 is coupled to both shaft parts 5 and 6. At one edge 9 the boot is rigidly fixed to the outer shaft part 6 by clamping means 14. At its other edge 10 the boot 8 is provided with a sealing lip 12 which makes sealing contact but is able to slide on the inner shaft part 5. Thus, displacement of the two shaft parts 5, 6 relative to one another causes relative motion of the edge 10 with respect to the shaft part 5, provided that the sealing lip 12 does not rest against a stop. The boot 8 has two functions. First, the boot forms a sealing cover which prevents the escape of lubricant from the longitudinal toothing 2 and prevents the entry of contaminants from the surroundings. Second, the boot 8 provides pull-out protection which is active in the state when the drive shaft 1 is removed from the vehicle. For transport and installation it must be ensured that the shaft parts 5 and 6 cannot be pulled apart, for example under the force of weight in the suspended state. This is achieved by a stop face on a stop in cooperation with the edge 10 of the boot 8 which is slidable on the shaft part 5.

Various embodiments of the boot 8 and the stop are illustrated in FIGS. 2 through 5. In the design according to FIG. 2, a clamping ring 11 which is displaceable on the actual shaft part 5 and which has a stop face oppositely situated from the sealing lip 12 is used as a stop. In the installed state of the drive shaft 1, the clamping ring 11 is freely pushed onto the shaft part 5 in the region between the end face of the outer toothing 3 and the edge 10, depending on the particular relative motions which the shaft parts 5, 6 undergo with respect to one another. Under the intrinsic weight in the removed state of the drive shaft 1, the clamping ring 1 lies against the end face of the outer toothing 3 of the inner shaft part 5, and prevents the edge 10 from being pulled over the outer toothing on account of its diameter, and under elongation the boot 8 absorbs the force of weight of the shaft part suspended thereon. For this purpose the edge 10 must be made of a material having appropriate radial rigidity.

The advantage of this design is that the boot 8 has a compact design but still allows large displacement paths of the shaft parts 5, 6 relative to one another in the installed state, since a portion of the required displacement path is represented by the displaceability of the edge 10 of the boot 8 relative to the shaft part 5.

The designs according to FIGS. 3 through 5 follow the same inventive concept. In this case, however, the stop for the edge 10 which is displaceable relative to the shaft part 5 is fixed, since it is formed by a projection 13 of the shaft part 5 which is formed by a difference in diameters. For this purpose, the diameter of the shaft part 5 in the region of the contacting edge 10 is kept smaller than the outer diameter of the longitudinal toothing 4, which therefore acts as a stop which prevents pull-out.

To increase the radial rigidity of the boot edge 10, according to FIG. 3 a spring washer 17 having a circular cross section is provided on the outer periphery of the boot 8. The spring washer 17 prevents expansion of the boot edge 10, so that even relatively high pull-out forces cannot pull the boot 8 over the stop. Instead of a spring washer 17 having a circular cross section, however, a spring washer having a rectangular cross section, for example a snap ring having a rectangular cross section, may be used. The spring washer 17 may have radial pretensioning to assist in the sealing.

Furthermore, in the design according to FIGS. 2 and 3 the sealing lip 12 is provided in the form of a narrow undulating arc, and is oriented on the stop, clamping ring 11, or projection 13 at an angle with respect to the pull-out direction. This has the advantage that when it strikes the stop 13 the sealing lip 12 raises up, thereby increasing the force against pulling out. At the same time, installation is simplified, since the sealing lip 12 is folded outward due to the inclined position for motion opposite the pull-out direction, resulting in expansion.

In the exemplary embodiment according to FIG. 4, for increasing the radial rigidity the edge 10 of the boot 8 is provided with two radially oriented undulating arcs which form sealing lips 12. The undulating arcs delimit a circumferential groove which is open toward the shaft part and in which a support ring 16 may be provided, which lies against the outer diameter of the shaft part 5. A tension coupling 15 provides resistance to radial expansion of the boot edge, and is used to produce pretensioning for the seal. The support ring 16 may be omitted if sufficient radial rigidity of the edge 10 of the boot is achieved as the result of suitable selection of the boot material, so that in conjunction with the tension coupling 15 the required sealing and protection from pull-out are ensured.

A tension coupling 15 is also used in the exemplary embodiment according to FIG. 5, except that in this case it is used to keep a flat edge 10 of the boot pressed against the shaft part 5.

The tension in the spring washer 17 or the tension coupling 15 is preferably adjusted so that the axially displaceable edge 10 is under pretensioning, which during transport or installation prevents the shaft parts 5, 6 from being accidentally pulled out, at least under the force of weight.

The displaceability of the shaft parts 5, 6 relative to one another is adjusted so that in the removed state, for a specified pull-out force the pull-out length of the internested shaft parts is greater, by a specifiable amount, than the maximum pull-out during operation. The extension length is fixed primarily by the extensibility of the boot 8 and by the path along which the edge 10 is able to slide relative to the shaft part 5. It is thus possible to achieve a compact boot 8 which, in addition to the function of pull-out protection, also performs the function of sealing, which represents an economical and simple approach. The pull-out protection according to the invention may thus be advantageously used in particular for drive shafts having limited available space.

1. Drive shaft (1) comprising partially internested shaft parts (5, 6) which are slidable relative to another by a predetermined amount in a longitudinal toothing (2), the longitudinal toothing (2) being formed by an inner toothing (4) on the outer, tubular shaft part (6) and by an outer toothing (3) on the inner shaft part (5), the shaft parts (5, 6) being joined together and prevented from being pulled apart axially during installation or transport by use of securing means provided on the outer periphery of the shaft parts, characterized in that
the securing means is provided by a boot (8) which encloses both shaft parts (5, 6) and whose edges (9, 10) cooperate with the shaft parts (5, 6) so as to limit pull-out and form a seal, and at at least one edge (10) the boot (8) is axially slidable to a limited extent relative to the shaft part (5) which it encloses.

2. Drive shaft according to claim 1, characterized in that within the boot (8), a stop in the form of a pull-out limiter is provided for the annular edge (10) of the boot (8) which is displaceable relative to the enclosed shaft part (5).

3. Drive shaft according to claim 2, characterized in that the stop is formed by a clamping ring (11) resting on the shaft part (5).

4. Drive shaft according to claim 3, characterized in that the clamping ring (11) is situated on the reduced-diameter section of the inner shaft part (5) adjoining the outer toothing (3), the clamping ring (11) being slidable on the inner shaft part (5) in both the pull-out direction by means of entrainment on the edge (10) of the boot (8), and in the direction opposite the pull-out direction by means of entrainment on the outer shaft part (6), and the displaceability of the clamping ring (11) in the pull-out direction being limited in particular by the outer toothing (3).

5. Drive shaft according to claim 2, characterized in that the stop is a pull-out-limiting projection (13) that is formed by a difference in diameters.

6. Drive shaft according to claim 5, characterized in that the projection (13) is formed by the end faces of the outer toothing (3) of the inner shaft part (5).

7. Drive shaft according to one of claim 2, characterized in that
the projection (13) has an inclined stop ramp.

8. Drive shaft according to one of claim 1, characterized in that the edge (10) of the boot (8) which is displaceable relative to the shaft part (5) is provided with a sealing lip (12).

9. Drive shaft according to claim 8, characterized in that the sealing lip (12) is oriented on the stop at an angle with respect to the pull-out direction.

10. Drive shaft according to one of claim 1, characterized in that the edge (10) of the boot (8) which is axially displaceable relative to the connected shaft part (5) is provided by undulating arcs which form two radially oriented sealing lips (12).

11. Drive shaft according to claim 10, characterized in that the two radially oriented sealing lips (12) delimit a circumferential groove which is open toward the shaft part (5), and in the circumferential groove a support ring (16) is provided which rests on the outer diameter of the shaft part (5).

12. Drive shaft according to one of claim 8, characterized in that the sealing lip (12) is designed in the form of a narrow undulating arc.

13. Drive shaft according to claim 8, characterized in that the sealing lip (12) has a collar-shaped design.

14. Drive shaft according to one of claim 8, characterized in that a tensioning element which is pretensioned against the shaft part (5) is provided on the back side of the sealing lip (12).

15. Drive shaft according to claim 14, characterized in that the tensioning element is designed as a spring washer (17) having a circular or rectangular cross section.

16. Drive shaft according to claim 14, characterized in that the tensioning element is a snap ring.

17. Drive shaft according to claim 14, characterized in that the tensioning element is a tension coupling (15).

18. Drive shaft according to one of claim 1, characterized in that the edge (10) which is axially displaceable relative to the connected shaft part (8) is under pretensioning, which during transport or installation prevents the shaft parts (5, 6) from being accidentally pulled out, at least under the force of weight.

19. Drive shaft according to one of claim 1, characterized in that the displaceability of the shaft parts (5, 6) relative to one another due to the edge (10) of the boot (8) relative to the connected shaft part (5) and due to the extensibility of the boot (8) is adjusted for a specified pull-out force in such a way that the pull-out length of the internested shaft parts (5, 6) is greater, by a specifiable amount, than the maximum pull-out during operation.
